(19) United States
(12) Patent Application Publication
(10) Pub. No.: US 2010/0113287 A1
(43) Pub. Date: May 6, 2010

(54) METHODS FOR ASSESSING THE REPRESENTATION OF NUCLEIC ACID MOLECULES IN A NUCLEIC ACID LIBRARY

(75) Inventors: Michele A. Cleary, Bothell, WA (US); Kristopher A. Kilian, Coogee (AU); Hongyue Dai, Kenmore, WA (US); Yanqun Wang, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Rosetta Inpharmatics LLC, Seattle, WA (US)

(21) Appl. No.: 12/563,304

(22) Filed: Sep. 21, 2009

Related U.S. Application Data
(63) Continuation of application No. 11/222,043, filed on Sep. 8, 2005, now abandoned.
(60) Provisional application No. 60/608,682, filed on Sep. 10, 2004.

(51) Int. Cl. C40B 30/00

(52) U.S. Cl. 506/7

(57) ABSTRACT

The invention provides methods for evaluating the representation of expected nucleic acid molecules in a test population of nucleic acid molecules. The methods each comprise the steps of: (a) hybridizing a population of sample nucleic acid molecules obtained from a test population of nucleic acid molecules to a substrate comprising a population of target nucleic acid molecules, wherein (i) each target nucleic acid molecule comprises a predetermined sequence corresponding to an expected nucleic acid molecule, and (ii) each target nucleic acid molecule is localized to a defined area of the substrate; and (b) evaluating the representation of expected nucleic acid molecules in the test population of nucleic acid molecules by analyzing the pattern of hybridization of the sample population of nucleic acid molecules to the target nucleic acid molecules.

### CROSS-REFERENCES TO RELATED APPLICATIONS

This application is a continuation of U.S. application Ser. No. 11/222,043, filed Sep. 8, 2005, which claims the benefit of U.S. Provisional Application No. 60/608,682, filed Sep. 10, 2004, the disclosures of which are expressly incorporated herein by reference.

### FIELD OF THE INVENTION

The present invention relates generally to the field of genomic analysis, and more particularly to methods for evaluating the representation of nucleic acid molecules in a nucleic acid library.

### BACKGROUND OF THE INVENTION

Nucleic acid libraries are useful in many contexts, for example, for performing genetic screens. Generally, a nucleic acid library is generated from a particular source of nucleic acid molecules, such as a genomic DNA from a particular organism, or mRNAs expressed in a particular tissue. Typically, the usefulness of any nucleic acid library depends on how accurately it represents the source of nucleic acid molecules that was used to create it, i.e., the extent to which it is representative of all the nucleic acids molecules it was designed to include. One way to evaluate the representation of a nucleic acid library is to determine the sequence of random clones derived from the library. This approach is cumbersome and provides only a rough estimate of the representation of intended sequences. There is a need in the art for improved methods for evaluating the representation of nucleic acid molecules in a nucleic acid library.

### SUMMARY OF THE INVENTION

The invention provides methods for evaluating the representation of expected nucleic acid molecules in a test population of nucleic acid molecules. The methods each comprise the steps of: (a) hybridizing a population of sample nucleic acid molecules obtained from a test population of nucleic acid molecules to a substrate comprising a population of target nucleic acid molecules, wherein (i) each target nucleic acid molecule comprises a predetermined sequence corresponding to an expected nucleic acid molecule and (ii) each target nucleic acid molecule is localized to a defined area of the substrate; and (b) evaluating the representation of expected nucleic acid molecules in the test population of nucleic acid molecules by analyzing the pattern of hybridization of the sample population of nucleic acid molecules to the target nucleic acid molecules. In some embodiments, the sample nucleic acid molecules are single-stranded RNA molecules and the target nucleic acid molecules are single-stranded DNA molecules. The sample nucleic acid molecules may be labeled before hybridization to the substrate. The substrate may comprise at least about 1,000 target nucleic acid molecules, such as at least about 30,000 target nucleic acid molecules. In some embodiments, the substrate comprises a nucleic acid molecule that provides a negative control for background hybridization. The pattern of hybridization may be analyzed using any suitable analytic method, such as, for example, cluster analysis.

In some embodiments, the methods of the invention comprise the steps of:

(a) synthesizing a population of labeled, single-stranded RNA sample molecules from a test population of nucleic acid molecules;

(b) hybridizing the population of labeled, single-stranded RNA molecules to a substrate comprising a population of target nucleic acid molecules, wherein:
(i) each target nucleic acid molecule comprises a predetermined sequence corresponding to an expected nucleic acid molecule, and
(ii) each target nucleic acid molecule is localized to a defined area of the substrate; and

(c) evaluating the representation of expected nucleic acid molecules in the test population of nucleic acid molecules by analyzing the pattern of hybridization of the labeled, single-stranded RNA molecules to the target nucleic acid molecules.

In further embodiments, the invention provides methods for evaluating the representation of expected nucleic acid molecules in a population of synthesized nucleic acid molecules. These methods comprise the steps of:

(a) synthesizing a population of nucleic acid molecules on a first substrate;

(b) harvesting the population of synthesized nucleic acid molecules from the first substrate to yield harvested nucleic acid molecules;

(c) synthesizing a population of labeled, single-stranded RNA molecules from the population of harvested nucleic acid molecules;

(d) hybridizing the population of labeled, single-stranded RNA molecules to a second substrate comprising a population of target nucleic acid molecules, wherein:
(i) each target nucleic acid molecule comprises a predetermined sequence corresponding to an expected nucleic acid molecule, and
(ii) each target nucleic acid molecule is localized to a defined area of the second substrate; and

(e) evaluating the representation of expected nucleic acid molecules in the population of synthesized nucleic acid molecules by analyzing the pattern of hybridization of the labeled, single-stranded RNA molecules to the target nucleic acid molecules.

The methods of the invention are useful for evaluating the representation of expected nucleic acid molecules in any type of nucleic acid library.

### BRIEF DESCRIPTION OF THE DRAWING

The foregoing aspects and many of the attendant advantages of this invention will become more readily appreciated as the same become better understood by reference to the following detailed description, when taken in conjunction with the accompanying drawing, wherein:

FIG. 1 shows a representative method of the invention for evaluating the representation of nucleic acid molecules in a nucleic acid library. A diagnostic array is designed to contain probes that can detect all the expected nucleic acid molecules of a test library. The nucleic acid molecules of the test library, or fragments from those nucleic acid molecules, are labeled with a detectable marker (e.g., fluorescent dye) either directly or indirectly (e.g., in vitro transcription products derived from the library members) as a pool. This labeled pool is then hybridized to the diagnostic array. If all expected sequences are present, all probes will show hybridization (top right, hybridization represented as grey circles). If some members of the library are missing, hybridization to the corresponding probes will not occur (bottom right, non-hybridization represented as open circles). Standard microarray analysis tools can be used to determine overall representation and identify missing library components.

### DETAILED DESCRIPTION OF THE PREFERRED EMBODIMENT

Unless specifically defined herein, all terms used herein have the same meaning as they would to one skilled in the art of the present invention. Practitioners are particularly directed to Sambrook et al., Molecular Cloning: A Laboratory Manual, 2d ed., Cold Spring Harbor Press, Plainview, N.Y., 1989, and Ausubel et al., Current Protocols in Molecular Biology (Supplement 47), John Wiley & Sons, New York, 1999, for definitions and terms of the art.

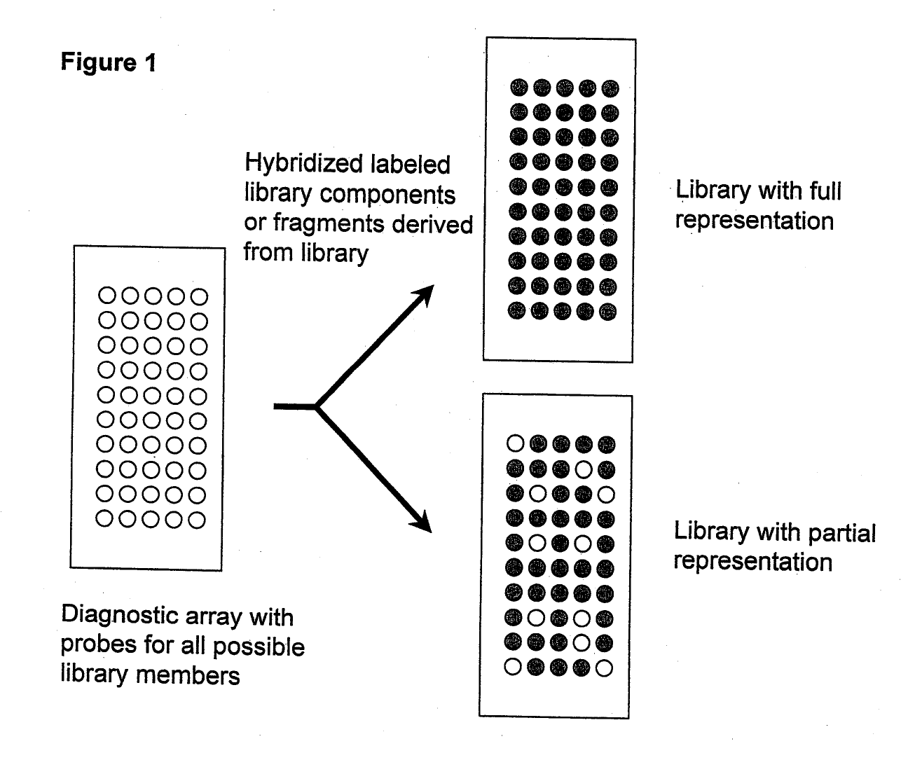

The invention provides methods for evaluating the representation of expected nucleic acid molecules in a test population of nucleic acid molecules. The methods each comprise the steps of: (a) hybridizing a population of sample nucleic acid molecules obtained from a test population of nucleic acid molecules to a substrate comprising a population of target nucleic acid molecules, wherein (i) each target nucleic acid molecule comprises a predetermined sequence corresponding to an expected nucleic acid molecule, and (ii) each target nucleic acid molecule is localized to a defined area of the substrate; and (b) evaluating the representation of expected nucleic acid molecules in the test population of nucleic acid molecules by analyzing the pattern of hybridization of the sample population of nucleic acid molecules to the target nucleic acid molecules. In some embodiments, the methods comprise the steps of evaluating the representation of expected nucleic acid molecules in a test population of nucleic acid molecules by analyzing the pattern of hybridization of a sample population of nucleic acid molecules to target nucleic acid molecules, wherein the population of sample nucleic acid molecules is obtained from the test population of nucleic acid molecules and is hybridized to a substrate comprising a population of target nucleic acid molecules, and wherein each target nucleic acid molecule comprises a predetermined sequence corresponding to an expected nucleic acid molecule and is localized to a defined area of the substrate. A representative method of the invention is schematically illustrated in FIG. 1.

As used herein, the term “nucleic acid molecule” encompasses both deoxyribonucleotides and ribonucleotides and refers to a polymeric form of nucleotides including two or more nucleotide monomers. The nucleotides can be naturally occurring, artificial and/or modified nucleotides. Examples of nucleic acid molecules include oligonucleotides, which typically range in length from 2 nucleotides to about 100 nucleotides, and polynucleotides, which typically have a length greater than about 100 nucleotides.

As used herein, the term “expected nucleic acid molecule” refers to a nucleic acid molecule that is desired or intended to be present in a population of nucleic acid molecules. An art-recognized term for a population of nucleic acid molecules is a “library” of nucleic acid molecules. The term “library” is usually, although not necessarily, applied to populations of nucleic acid molecules that have been introduced into vector molecules that facilitate expression of the nucleic acid molecules to yield other nucleic acid molecules (e.g., RNA molecules) and/or proteins (or fragments of complete proteins). As used herein, the term “library” or “population of nucleic acid molecules” also includes a population of nucleic acid molecules that have not been introduced into vector molecules, such as, for example, a collection of nucleic acid molecules on a substrate or in solution. The term “test population of nucleic acid molecules” refers to any library in which the representation of expected nucleic acid is to be evaluated using the methods of the invention. The methods of the invention may be used to evaluate the representation of expected nucleic acid molecules in any type of library, including, but not limited to, cDNA libraries, EST libraries, PCR fragment libraries, phage display libraries, RNA interference libraries, genomic sequence libraries, libraries for antibody diversity studies, libraries for combinatorial peptide sequence generation, libraries for DNA binding site selection, libraries for promoter structural analysis, libraries for identification of regulatory sequences, libraries for restriction enzyme recognition site analysis, libraries for short hairpin RNA (shRNA) expression, libraries of small interfering RNAs (siRNAs) or for siRNA expression, libraries for chromosomal probe generation, libraries for genomic insertional mutagenesis, libraries for creation of nucleic acid multimers, and libraries for screening sequences for protein domain solubility in expression systems. For example, the methods of the invention may be used to evaluate the representation of a cDNA library that is designed to include all nucleic acid molecules that correspond to mRNA molecules expressed in a particular tissue, such as human brain. Thus, the human brain cDNA library (i.e., the test population of nucleic acid molecules) is evaluated to determine whether the nucleic acid molecules present in the human brain cDNA library are representative of all mRNA molecules that are known to be expressed in human brain.

In the methods of the invention, a sample population of nucleic acid molecules obtained from a test population of nucleic acid molecules is hybridized to a substrate comprising a population of target nucleic acid molecules. The term “sample population of nucleic acid molecules” refers to a population of nucleic acid molecules that corresponds to a test population of nucleic acid molecules. As used herein, a nucleic acid molecule “corresponds” to another nucleic acid molecule if it comprises a sequence that is identical to or complementary to the sequence of all or part of the other nucleic acid molecule. For example, the nucleic acid molecules in the test population may be double-stranded DNA molecules and the corresponding nucleic acid molecules in the sample population may be single-stranded RNA molecules transcribed from the double-stranded DNA molecules in the test population.

A sample population of nucleic acid molecules may be obtained from the test population of nucleic acid molecules by any method of generating a population of corresponding nucleic acid molecules. Thus, a sample population of nucleic acid molecules may be obtained by removing an aliquot of the test population of nucleic acid molecules, or by any method of reproducing, amplifying, or transcribing the test population of nucleic acid molecules. Amplification may be achieved using any method of nucleic acid molecule amplification, including, for example, polymerase chain reaction (PCR), ligase chain reaction (Wu and Wallace, Genomics 4:560-569, 1989; Landegren et al., Science 241:1077-1080, 1988), transcription amplification (Kwoh et al., Proc. Natl. Acad. Sci. U.S.A. 87:1874-1878, 1990), self-sustained sequenced replication (Guantelli et al., Proc. Natl. Acad. Sci. U.S.A. 87:1874-1878, 1987), and nucleic acid based sequence amplification (NASBA).

PCR amplification methods are well known in the art and are described, for example, in Innis et al., PCR Protocols: A Guide to Methods and Applications, Academic Press Inc. San Diego, Calif., 1990. An amplification reaction typically includes the DNA that is to be amplified, a thermostable DNA polymerase, two oligonucleotide primers, deoxynucleotide triphosphates (dNTPs), reaction buffer and magnesium. Typically a desirable number of thermal cycles is between 1 and 25. Methods for primer design and optimization of PCR conditions are well known in the art and can be found in standard molecular biology texts such as Ausubel et al., Short Protocols in Molecular Biology, Wiley, 1995, and Innis et al., PCR Protocols, Academic Press, 1990.

Any primers that are complementary to a portion of the nucleic acid molecules that are synthesized on the substrate can be used to prime the polymerase chain reaction. For example, in one embodiment, a primer hybridizes to the 5′ primer binding region of the nucleic acid molecule to be amplified, and the same primer, or a different primer, hybridizes to the 3′ primer binding region of the nucleic acid molecule to be amplified. In another representative embodiment, a primer hybridizes to the target identifier sequence of the nucleic acid molecule to be amplified, and a different primer hybridizes to the 3′ primer binding region of the nucleic acid molecule to be amplified. The primer binding regions of the nucleic acid molecules to be amplified, and hence the corresponding complementary PCR primers, preferably range in length from about 4 to about 30 nucleotides. Computer programs are useful in the design of primers with the required specificity and optimal amplification properties (e.g., Oligo Version 5.0 (National Biosciences)). In some embodiments, the PCR primers may additionally contain recognition sites for restriction endonucleases, to facilitate insertion of the amplified DNA fragment into specific restriction enzyme sites in a vector. If restriction sites are to be added to the 5′ end of the PCR primers, it is preferable to include a few (e.g., two or three) extra 5′ bases to allow more efficient cleavage by the enzyme. In some embodiments, the PCR primers may also contain an RNA polymerase promoter site, such as T7 or SP6, to allow for subsequent in vitro transcription. Methods for in vitro transcription are well known to those of skill in the art (see, e.g., Van Gelder et al., Proc. Natl. Acad. Sci. U.S.A. 87:1663-1667, 1990; Eberwine et al., Proc. Natl. Acad. Sci. U.S.A. 89:3010-3014, 1992).

The sample nucleic acid molecules are typically labeled prior to hybridization, for example, by directly attaching a label to the sample nucleic acid molecules using standard molecular biological techniques, or by synthesizing labeled sample nucleic acid molecules. For example, a test population of double-stranded DNA molecules may be used as templates for synthesizing labeled sample RNA molecules by in vitro transcription.

As used herein, the term “target nucleic acid molecule” refers to a nucleic acid molecule that corresponds to an expected nucleic acid molecule. Thus, a target nucleic acid molecule comprises a predetermined nucleic acid sequence that is identical to or complementary to the sequence of all or part of an expected nucleic acid molecule. The phrase “predetermined nucleic acid sequence” means that the nucleic acid sequence of a nucleic acid molecule is previously known. In some embodiments, the target nucleic acid molecules are single-stranded DNA molecules.

According to the methods of the invention, the population of target molecules is present on a substrate, typically a flat substrate, which may be textured or treated to increase surface area. The surface of the substrate typically has, or is chemically modified to have, reactive groups suitable for attaching organic molecules. Examples of such substrates include, but are not limited to, glass, silica, silicon, plastic (e.g., polypropylene, polystyrene, Teflon™, polyethylimine, nylon, polyester), polyacrylamide, fiberglass, nitrocellulose, cellulose acetate, or other suitable materials. In some embodiments, glass is the preferred substrate. The substrate may be treated in such a way as to enhance the attachment of nucleic acid molecules. For example, a glass substrate may be treated with polylysine or silane to facilitate attachment of nucleic acid molecules. Silanization of glass surfaces for oligonucleotide applications has been described (Halliwell et al., Anal. Chem. 73:2476-2483, 2001). In some embodiments, the surface of the substrate to which nucleic acid molecules are attached bears chemically reactive groups, such as carboxyl, amino, hydroxyl and the like (e.g., Si—OH functionalities, such as are found on silica surfaces).

The surface of the substrate may be treated with radiation, or a protectant or reactant species over selected areas, and the unprotected areas are then coated with a hydrophobic agent to yield a chemically differentiated surface. Thus, some areas of the surface are available for attachment of nucleic acid molecules, while others are not. For example, a hydrophobic coating may be created by chemical deposition of tridecafluorotetrahydrooctyl triethoxysilane onto exposed oxide surrounding the protected areas. The protectant is removed, exposing the regions of the substrate to further modification and synthesis of nucleic acid molecules (Maskos and Southern, Nucl. Acids Res. 20:1679-1684, 1992). By way of example, a glass substrate may be coated with a hydrophobic material, such as 3-(1,1-dihydroperfluoroctyloxy)propyltriethoxysilane, which is ablated at desired loci to expose the underlying silicon dioxide glass, which is subsequently treated with hexaethylene glycol and sulfuric acid to form an hydroxyl group-bearing linker upon which chemical species can be synthesized (see, e.g., U.S. Pat. No. 5,474,796, issued to Brennan). The protectant and the hydrophobic coating may be applied in any desired pattern by, for example, a printing process using a rubber stamp, a silk-screening process, or a laser printer with a hydrophobic toner.

In some embodiments of the methods of the invention, linker molecules are attached to the substrate and the target nucleic acid molecules are attached to the end of the linker molecules. Examples of useful linker molecules include, for example, silane, aryl acetylene, ethylene glycol, diamines, diacids, amino acids, peptide molecules including protease recognition sites, or combinations thereof. The linker molecules may be attached to the substrate via carbon-carbon bonds using, for example, (poly)trifluorochloroethylene surfaces, or, for example, by siloxane bonds to glass or silicon oxide surfaces. Methods of silanization of glass surfaces for oligonucleotide attachment are further described in Halliwell et al., Anal. Chem. 73:2476-2483, 2001.

The linker molecules may be attached, for example, in an ordered array, such as parts of head groups in a polymerized Langmuir Blodgett film, or as a self-assembling monomer (Silberzan et al., Langmuir 7:1647-1651, 1991). The linker molecules may be provided with a functional group to which is bound a protective group, such as a photolabile protecting group. In some embodiments, the linker contains a photocleavable spacer such as photocleavable spacer phosphoramidite monomers (available from Glen Research, 22825 Davis Drive, Sterling, Va. 20164), which can be synthesized on a silanized glass substrate with hydroxyl functionality. In some embodiments, the target nucleic acid molecules are directly attached to a linker by an ester bond. By way of non-limiting example, a silane linker may be covalently attached to a silica surface of the substrate and the first nucleotide of a target nucleic acid molecule is synthesized directly onto the hydroxyl group on the silane linker.

The population of target nucleic acid molecules may be attached to or synthesized on a substrate by any art-recognized means. Methods for attaching pre-synthesized nucleic acid molecules to a substrate are known in the art and are described, for example, in Eisen and Brown, Methods Enzymol. 303:179-205, 1999. Methods for synthesizing a population of target nucleic acid molecules on a substrate include, but are not limited to, photolithography (Lipshutz et al., Nat. Genet. 21(1 Suppl):20-24), 1999, and piezoelectric printing (Blanchard et al., Biosensors & Bioelectronics 11:687-690, 1996). In some embodiments, target nucleic acid molecules are synthesized in a defined pattern on a solid substrate to form a high-density microarray. Techniques are known for producing arrays containing thousands of oligonucleotides comprising defined sequences at defined locations on a substrate (see e.g., Pease et al., Proc. Natl. Acad. Sci. U.S.A. 91:5022-5026, 1994; Lockhart et al., Nature Biotechnol. 14:1675-1680, 1996; Lipshutz et al., Nat. Genet. 21(1 Suppl):20-24), 1999.

In some embodiments, target nucleic acid sequences are synthesized on a substrate, to form a high density microarray, by means of an ink jet printing device for oligonucleotide synthesis, such as described by Blanchard in U.S. Pat. No. 6,028,189; Blanchard et al., Biosensors & Bioelectrics 11:687-690, 1996; Blanchard, Synthetic DNA Arrays in Genetic Engineering, Vol. 20, Setlow, ed., Plenum Press, New York, pp. 111-123, and U.S. Pat. No. 6,028,189, issued to Blanchard.

The nucleic acid sequences in such microarrays are typically synthesized in arrays, for example on a glass slide, by serially depositing individual nucleotide bases in “microdroplets” of a high surface tension solvent such as propylene carbonate. The microdroplets have small volumes (e.g., 100 picoliters (pL) or less, or 50 pL or less) and are separated from each other on the microarray (e.g., by hydrophobic domains) to form surface tension wells which define the areas containing the array elements (i.e., the different populations of nucleic acid molecules). Microarrays manufactured by this ink-jet method are typically of high density, typically having a density of at least about 2,000 different nucleic acid molecules per 1 cm². The nucleic acid molecules may be covalently attached directly to the substrate, or to a linker attached to the substrate at either the 3′ or 5′ end of the polynucleotide. In the practice of the present invention, exemplary chain lengths of the synthesized nucleic acid molecules are in the range of about 20 to about 100 nucleotides in length, such as 50 to 100, 60 to 100, 70 to 100, 80 to 100, or 90 to 100 nucleotides in length. In some embodiments, the nucleic acid molecules are in the range of 80 to 100 nucleotides in length.

Exemplary ink jet printing devices suitable for oligonucleotide synthesis in the practice of the present invention contain microfabricated ink-jet pumps, or nozzles, which are used to deliver specified volumes of synthesis reagents to an array of surface tension wells (Kyser et al., J. Appl. Photographic Eng. 7:73-79, 1981). The pumps can be made, for example, by using etching techniques known to those skilled in the art to fabricate a shallow cavity and channels in silicon. A thin glass membrane is then anodically bonded to the silicon to seal the etched cavity, thus forming a small reservoir with narrow inlet and exit channels. When the inlet end of the pump is dipped in the reagent solution, capillary action draws the liquid into the cavity until it comes to the end of the exit channel. When an electrical pulse is applied to the piezoelectric element glued to the glass membrane it bows inward, ejecting a droplet out of the orifice at the end of the pump. For oligonucleotide synthesis in two dimensional arrays, pumps that deliver 100 pL droplets or less on demand at rates of several hundred Hertz (Hz) are applicable. However, the droplet volume or speed of the pump can vary depending on the need. For example, if a larger array is to be synthesized with the same surface area, then smaller droplets should be dispensed. Additionally, if synthesis time is to be decreased, then operation speed can be increased. Such parameters are known to those skilled in the art and can be adjusted according to the need (see, e.g., U.S. Pat. No. 6,028,189, issued to Blanchard).

DNA synthesis can be carried out by any art-recognized chemistry, including phosphodiester, phosphotriester, phosphate triester or N-phosphonate and phosphoramidite chemistries (see e.g., Froehler et al., Nucl. Acid Res. 14:5399-5407, 1986; McBride et al., Tetrahedron Lett. 24:246-248, 1983). Methods of oligonucleotide synthesis are well known in the art and generally involve coupling an activated phosphorous derivative on the 3′ hydroxyl group of a nucleotide with the 5′ hydroxyl group of the nucleic acid molecule (see, e.g., Gait, Oligonucleotide Synthesis: A Practical Approach, IRL Press, 1984).

By way of example, a nucleotide having an activated phosphoramidite group at the 3′ position, and a protected hydroxyl group at the 5′ position, reacts with a nucleic acid molecule, attached to a substrate, having a thiol or hydroxyl group at its 5′ position that is capable of forming a stable covalent bond with the phosphoramidite group at the 3′ position. Each coupling step adds one nucleotide to the end of the attached nucleic acid molecule. After excess nucleotide monomer is washed away, a deprotection step reactivates the new end of the molecule for the next cycle (Blanchard et al., Biosensors & Bioelectronics 11(6/7):687-690, 1996).

Suitable nucleotides useful in the synthesis of nucleic acid molecules include nucleotides that contain activated phosphorus-containing groups such as phosphodiester, phosphotriester, phosphate triester, H-phosphonate and phosphoramidite groups. In some embodiments, nucleic acid molecules can be synthesized using modified nucleotides, or nucleotide derivatives, such as for example, combinations of modified phosphodiester linkages such as phosphorothiate, phosphorodithioate and methylphosphonate, as well as nucleotides having modified bases such as inosine, 5′-nitroindole and 3′ nitropyrrole. Additionally, it is possible to vary the charge on the phosphate backbone of the nucleic acid molecule, for example, by thiolation or methylation, or to use a peptide rather than a phosphate backbone. The making of such modifications is within the skill of one trained in the art.

Synthesis of nucleic acid molecules comprising RNA can similarly be accomplished using the present methods. A range of modifications can be introduced into the base, the sugar, or the phosphate portions of oligoribonucleotides, e.g., by preparation of appropriately protected phosphoramidite or H-phosphonate ribonucleoside monomers, and/or coupling such modified forms into oligoribonucleotides by solid-phase synthesis. Modified ribonucleoside analogues include, for example, 2′O-methyl, 2′-O-allyl, 2′-fluoro, 2′-amino phosphorothioate, 2′-O-Me methylphosphonate, 5′-O-Silyl-2′-O-ACE, 2′-O-TOM, alpha-ribose and 2′-5′-linked ribonucleoside analogs.

In some embodiments of the method of the invention, a population of target nucleic acid molecules is disposed on a substrate to form a high-density microarray. A DNA microarray, or chip, is an array of nucleic acid molecules, such as synthetic oligonucleotides, disposed in a defined pattern onto defined areas of a solid support (see, e.g., Schena, BioEssays 18:427, 1996). The arrays are preferably reproducible, allowing multiple copies of a given array to be produced and easily compared with each other. Microarrays are typically made from materials that are stable under nucleic acid molecule hybridization conditions. In some embodiments, the nucleic acid molecules on the array are single-stranded DNA sequences. Exemplary microarrays and methods for their manufacture and use are set forth in Hughes et al., Nat. Biotechnol. 19:342-347, 2001, which publication is incorporated herein by reference.

Exemplary sizes (expressed as surface area) for microarrays are between 1 cm² and 25 cm², such as between 12 cm² and 13 cm² (by way of specific example, 3 cm²). However, larger or smaller arrays are also contemplated.

In specific embodiments, DNA microarrays used in accordance with the present invention have a density of at least about 150 nucleic acid molecules per 1 cm² or higher. In some embodiments, DNA microarrays used in the methods of the present invention have at least 550, at least 1000, at least 1,500 or at least 2,000 nucleic acid molecules per 1 cm². In some embodiments, the DNA microarrays are high density arrays, for example having a density of at least about 2,000 predetermined nucleic acid molecules per 1 cm² (e.g., at least 2,000, at least 5,000, at least 10,000, at least 15,000, at least 20,000, at least 25,000, at least 50,000, at least 55,000, at least 100,000, or at least 150,000 predetermined nucleic acid molecules per 1 cm²).

In some embodiments, the array is a positionally addressable array in that each nucleic acid molecule of the array is localized to a known, defined area on the substrate such that the identity (i.e., the sequence) of each nucleic acid molecule can be determined from its position on the array (i.e., on the substrate surface). For example, a substrate may have at least from about 1,000 to about 30,000 separate defined areas. In some embodiments of the methods of the invention, the substrate comprises at least about 1,000 target nucleic acid molecules. In some embodiments, the substrate comprises at least about 30,000 target nucleic acid molecules. In addition to the target nucleic acid molecules, the substrate may comprise one or more nucleic acid molecules that provide a negative control for background hybridization. A negative control nucleic acid molecule generally comprises a predetermined nucleic acid sequence that is not expected to hybridize to the sample population of nucleic acid molecules.

Methods for hybridizing a sample population of nucleic acid molecules to a substrate comprising a population of target molecules are well known in the art. An exemplary method for hybridizing a sample population of nucleic acid molecules to a substrate comprising a population of target molecules is described, for example, in Hughes et al., Nat. Biotechnology 19:342-347, 2001.

In the methods of the invention, the representation of expected nucleic acid molecules in the test population of nucleic acid molecules is evaluated by analyzing the pattern of hybridization of the sample population of nucleic acid molecules to the target nucleic acid molecules. Typically, the pattern of hybridization is analyzed by examining both the distribution and the intensity of hybridization signals. Any technique for measuring and analyzing the pattern of hybridization may be used in accordance with the methods of the invention. In some embodiments, the pattern of hybridization is analyzed using cluster analysis using, for example, a Cluster Analysis software program described in Eisen et al., Proc. Natl. Acad. Sci. U.S.A. 95:14863, 1998, or an open source microarray data analysis software program TM4, described by Saeed et al., BioTechniques 34:374-378, 2003. The pattern of hybridization may also be analyzed using commercial gene expression analysis software programs, such as, for example, Rosetta Resolver® Gene Expression Data Analysis System (Rosetta Biosoftware, Seattle Wash.). An exemplary method for analyzing the pattern of hybridization of the sample population of nucleic acid molecules to the target nucleic acid molecules is described in EXAMPLE 1.

In some embodiments, the methods of the invention comprise the steps of:

(a) synthesizing a population of labeled, single-stranded RNA sample molecules from a test population of nucleic acid molecules;

(b) hybridizing the population of labeled, single-stranded RNA molecules to a substrate comprising a population of target nucleic acid molecules, wherein:
(i) each target nucleic acid molecule comprises a predetermined sequence corresponding to an expected nucleic acid molecule, and
(ii) each target nucleic acid molecule is localized to a defined area of the substrate; and

(c) evaluating the representation of expected nucleic acid molecules in the test population of nucleic acid molecules by analyzing the pattern of hybridization of the labeled, single-stranded RNA molecules to the target nucleic acid molecules.

In these embodiments of the methods of the invention, the sample nucleic acid molecules are labeled, single-stranded RNA molecules. A population of labeled, single-stranded RNA molecules may be synthesized from a test population of nucleic acid molecules using any methods known in the art. For example, labeled, single-stranded RNA may be synthesized from a test population of double-stranded DNA molecules by in vitro transcription, as described above. The test population of nucleic acid molecules may first be amplified using primers that provide an RNA polymerase promoter site, such as T7 or SP6, to allow for subsequent in vitro transcription of the amplified nucleic acid molecules. For example, use of primers comprising a T7 promoter sequence renders the amplification products ready for T7 polymerase in vitro transcription (IVT).

Methods for hybridizing the labeled, single-stranded RNA molecules to a substrate comprising target nucleic acid molecules, and methods for analyzing the pattern of hybridization, are as described above.

In further embodiments, the invention provides methods for evaluating the representation of expected nucleic acid molecules in a population of synthesized nucleic acid molecules. These methods comprise the steps of:

(a) synthesizing a population of nucleic acid molecules on a first substrate;

(b) harvesting the population of synthesized nucleic acid molecules from the first substrate to yield harvested nucleic acid molecules;

(c) synthesizing a population of labeled, single-stranded RNA molecules from the population of harvested nucleic acid molecules;

(d) hybridizing the population of labeled, single-stranded RNA molecules to a second substrate comprising a population of target nucleic acid molecules, wherein:
(i) each target nucleic acid molecule comprises a predetermined sequence corresponding to an expected nucleic acid molecule, and
(ii) each target nucleic acid molecule is localized to a defined area of the second substrate; and

(e) evaluating the representation of expected nucleic acid molecules in the population of synthesized nucleic acid molecules by analyzing the pattern of hybridization of the labeled, single-stranded RNA molecules to the target nucleic acid molecules.

In these embodiments of the methods of the invention, the test population of nucleic acid molecules is a population of synthesized nucleic acid molecules. In some embodiments, each synthesized nucleic acid molecule comprises a predetermined nucleic acid sequence, and is localized to a defined area of the first substrate. Methods for synthesizing a population of nucleic acid molecules on a substrate are as described above. To facilitate amplification of synthesized nucleic acid molecules, each synthesized nucleic acid molecule may include a 5′ primer binding region, and a 3′ primer binding region. Typically, the 5′ primer binding region and the 3′ primer binding region of the synthesized nucleic acid molecules range in length from about 4 to about 30 nucleotides, and may include restriction enzyme cleavage sites. The nucleotide sequences of the 5′ binding region and 3′ primer binding region may be chosen to allow for efficient amplification and typically have an annealing temperature within about 20° C. of each other. Computer programs are useful in the design of primers with the required specificity and optimal amplification properties (see, e.g., Oligo version 5.0, available from National Biosciences Inc., 3001 Harbor Lane, Suite 156, Plymouth, Minn. 55447-5434). The same 5′ primer binding region and/or 3′ primer binding region may be present in all of the synthesized nucleic acid molecules, or a particular 5′ primer binding sequence or 3′ primer binding sequence may be present in only a subpopulation of the synthesized nucleic acid molecules, thereby allowing for selective amplification of the subpopulation of the synthesized nucleic acid molecules.

The synthesized nucleic acid molecules may be harvested from the substrate by any useful means. In some embodiments, the portion of the nucleic acid molecule that is directly attached to the substrate, or attached to a linker that is attached to the substrate, is attached to the substrate or linker by an ester bond that is susceptible to hydrolysis by exposure to a hydrolyzing agent, such as hydroxide ions, for example, an aqueous solution of sodium hydroxide or ammonium hydroxide (see, e.g., LeProust et al., Nucleic Acids Res. 29:2171-2180). The entire substrate may be treated with hydrolyzing agent, or alternatively, a hydrolyzing agent can be applied to a portion of the substrate. For example, a silane linker may be cleaved by exposure of the silica surface to ammonium hydroxide, yielding various silicate salts and releasing the nucleic acid molecules with silane linker into solution. In some embodiments, ammonium hydroxide may be applied to the portion of a substrate that is covalently attached to the nucleic acid molecules, thereby releasing the nucleic acid molecules into solution (Scott and McLean, Innovations and Perspectives in Solid Phase Synthesis, 3rd International Symposium, Mayflower Worldwide, pp. 115-124, 1994). The present inventors have observed that ammonium hydroxide can be used to harvest synthesized nucleic acid molecules from a substrate, even if the synthesized nucleic acid molecules are not attached to the substrate by a chemical bond that is cleavable using ammonium hydroxide. While not wishing to be bound by theory, the ammonium hydroxide may etch or scrape the substrate to release the synthesized nucleic acid molecules therefrom. In embodiments comprising a photocleavable linker, the linker can be cleaved by exposure to light of appropriate wavelength, such as for example, ultra violet light, to harvest the nucleic acid molecules from the substrate (Olejnik & Rothschild, Meth. Enzymol. 291:135-154, 1998). The size of each defined area on a substrate may be chosen to allow for efficient cleavage of the synthesized nucleic acids. For example, in one embodiment, approximately 0.3 fmole of DNA is present per defined area.

Typically, harvested nucleic acid molecules are single stranded DNA molecules which may require second-strand synthesis to form double stranded DNA molecules. Second-strand synthesis may be achieved, for example, by first annealing a DNA oligonucleotide primer to a portion of each of the synthesized nucleic acid molecules (e.g., annealing a primer that hybridizes to a primer binding region). A DNA polymerizing enzyme, such as Taq polymerase or the Klenow fragment of E. coli DNA polymerase I, is then added to complete second-strand synthesis, resulting in double-stranded DNA molecules. Second strand synthesis can also occur, for example, during the first cycle of a series of amplification reactions (e.g., PCR reactions).

Methods for synthesizing a population of labeled, single-stranded RNA molecules from the population of harvested nucleic acid molecules, for hybridizing the labeled, single-stranded RNA molecules to a substrate comprising target nucleic acid molecules, and for analyzing the pattern of hybridization, are as described above. An exemplary embodiment of the methods for evaluating the representation of expected nucleic acid molecules in a population of synthesized nucleic acid molecules is described in EXAMPLE 1.

The following example illustrates representative embodiments now contemplated for practicing the invention, but should not be construed to limit the invention.

### Example 1

This example describes a representative method for evaluating the representation of target nucleic acid molecules in a sample population of nucleic acid molecules.

### Materials and Methods

Oligonucleotide Design and Microarray Synthesis: Sequences to be included in a library were designed such that each was flanked by 5′ and 3′ common 14- to 18-base PCR primer recognition sites. Oligonucleotide microarrays were printed at Agilent Technologies or synthesized at Rosetta using piezo ink-jet technology as described previously (Hughes et al., Nat. Biotechnol. 19:342-347, 2001). Prior to harvesting the oligonucleotides, quality control testing was performed using a functional hybridization of representative arrays that were produced on the same manufactured glass substrates.

Oligonucleotide Cleavage with a Photocleavable Spacer: Photocleavable (PC) spacer phosphoramidite (Glen Research, VA) monomers were synthesized on a silanized 3″×3″×0.004″ glass wafer with hydroxyl functionality. Silanization of glass surfaces for oligonucleotide applications have been described (Bourdieu et al., Phys. Rev. Lett. 7:2029-2032, 1991; Halliwell and Cass, Anal. Chem. 73:2476-2483, 2001) and silanes with various functionality are commercially available (Gelest, Pa.). All reaction steps and reagent preparations were performed under nitrogen in a PLAS-LABS, 830-ABC glove box (PLAS-LABS, MI). Anhydrous acetonitrile (1 mL; Fisher Scientific, NH) was added via syringe injection to 100 micromoles of freeze-dried PC Spacer Phosphoramidite to yield a 0.1 M solution. Anhydrous acetonitrile (62 mL) was then added to 2 g of freeze-dried 5-ethylthiol-1H-tetrazole (Glen Research, VA) to yield a 0.25 M solution for phosphoramidite activation. The solutions were vortexed briefly and allowed to equilibrate at room temperature for 30 minutes. The tetrazole solution (1 mL) was transferred by syringe to the PC spacer solution and the mixture vortexed for 10 seconds. Two silanized wafers were placed ‘reactive side up’ and 2 mL of the active PC/tetrazole solution was added to the surface of the first wafer. The second wafer was placed sandwich-like on the first, allowing the fluid to distribute uniformly between the surfaces. The wafers were incubated at room temperature for 2 minutes, separated, placed in a Teflon™ rack and immersed in a bath of acetonitrile. The rack was agitated in the bath for 2 minutes to ensure complete rinsing of excess PC spacer and dried by centrifugation. Formation of the stable pentavalent phosphodiester and removal of the dimethoxytrityl protecting group were carried out per standard oligonucleotide synthesis procedures (Brown, Meth. Mol. Biol. 20:1-17, 1993; Hughes et al., Nat. Biotechnol. 19:342-347, 2001). Synthesis of oligonucleotides on PC spacer functionalized substrates was performed as described above.

For arrays synthesized with a photocleavable linker, the oligonucleotides were cleaved in 1 mL of 25 mM Tris-buffer solution (pH 7.4) under UV irradiation (300-nm wavelength) for 30 minutes. The solution was transferred to a 1.5-mL microcentrifuge tube and speed vacuumed at low heat overnight.

Oligonucleotide Cleavage Using Ammonium Hydroxide: To cleave oligonucleotides synthesized without a photocleavable linker, the microarrays were treated for 2 hours with 2-3 mL of 35% NH₄OH solution (Fisher Scientific) at room temperature. The solution was transferred to 1.5-mL microcentrifuge tubes and speed vacuum dried at medium heat (˜55° C.) overnight.

PCR Amplification of Cleaved Oligonucleotides: Dried material containing oligonucleotides cleaved from each microarray was resuspended in 250 microliters of RNase/DNase-free H₂O. For PCR template, a range of volumes (0.1-5.0 microliters) was tested to determine the amount that gave the best yield with the lowest incidence of non-specific product. PCR samples were 50 microliters total containing 1× PCR buffer minus Mg (Invitrogen), 9% sucrose, 1.5 mM MgCl₂, 1 ng/microliter forward and reverse primers, 125 microM dNTPs, and 0.05 U/microliter Taq polymerase. Thermocycler conditions depended on the length of the oligonucleotides and the melting temperatures of the forward and reverse primers. In general, 30 cycles of 94° C. denaturing for 30 seconds, annealing at the appropriate temperature for 30 seconds, and extension at 72° C. for 90 seconds worked well. If the PCR products were to be cloned using a TA cloning system such as the Topo/TA cloning system (Invitrogen), Taq polymerase was used and the 30-cycle PCR was followed with a 10 minute extension at 72° C. For the cloning of shRNA libraries, the use of Vent polymerase or Pfx polymerase in the presence of DMSO and/or betaine reduced the incidence of nucleotide misincorporation during the PCR. Conditions were optimized separately for each primer set used. In some cases, PCR products were cleaned up by gel purification using the QIAquick Gel Extraction protocol (QIAgen). In other cases, the PCR products were simply cleaned up following a QIAquick PCR purification protocol (QIAgen).

Cloning and Sequencing of PCR Products: PCR products were cloned using a Topo/TA cloning system (Invitrogen) according to the manufacturer's instructions. Clones identified to contain inserts of approximately the correct size were prepped using a QIAgen miniprep kit and outsourced for sequence analysis.

Reverse Transcription/In Vitro Transcription (RT/IVT) and Microarray Hybridization:

To prepare templates for T7 in vitro transcription, PCR material from two individual reactions was pooled. Unincorporated nucleotides and polymerase were removed from the pooled PCR products by QIAquick PCR purification (QIAgen) with elution in 50 microliters of RNAse/DNase-free water. Eluates were speed-vacuum dried to concentrate two-fold and 7.25 microliters was used as template in a T7 RNA polymerization reaction using a modified Megashortscript protocol (Ambion). In lieu of 2 microliters of 75 mM UTP, 2.25 microliters of 50 mM amino allyl UTP (aa-UTP; Ambion) plus 0.5 microliters of the 75 mM UTP provided with the kit was used. The reactions were carried out at 37° C. overnight. Then, 1 microliters of DNase was added for 15 minutes at room temperature. Next, the samples were phenol/chloroform/isoamyl alcohol extracted and ethanol precipitated. Final resuspension was in 40 microliters of water.

Amino allyl-UTP incorporated cRNA was aliquoted into two, 96-well plates (5 micrograms per reaction well). One plate for Cy3 NHS-esther coupling and one for Cy5 NHS-esther coupling were prepared (dyes were obtained from Amersham Biosciences, NJ). Samples were reacted with the dyes and mixed for performance of two color ratio experiments and subsequently purified using BIO-RAD Micro Bio-Spin columns P-30 Tris (Bio-Rad Laboratories, CA). Purified dye-labeled samples were then hybridized for 24 hours to the detection microarray, washed, scanned on an Agilent Scanner and analyzed. Rosetta standard coupling and hybridization processes were employed as previously described (Hughes et al., Nat. Biotechnol. 19:342-347, 2001).

### Results and Discussion

Microarray technology was used to provide a visual representation of the representation of the printed sequences in the pool of material prior to cloning. A standard microarray hybridization strategy was used. A full-set sequence file containing 18,723 unique 96-base oligonucleotides encoding short hairpin RNAs was printed and cleaved. Multiple G-C base pairs in the stem sequences of these encoded shRNAs were converted to G-U base pairs to alleviate secondary structure at the DNA level. In addition, four subset files containing 5,152 of the 18,723 sequences each were printed. The four subset arrays were designed such that each array overlapped the subsequent array by ˜600 sequences. A T7 promoter-adapted PCR primer was used to prepare double-stranded templates for in vitro transcription (IVT) following cleavage and PCR. T7 transcription of these templates was carried out in the presence of aa-UTP, which allowed coupling of the resulting IVT products to Cy3 and Cy5 dyes. After coupling, dye-labeled material was hybridized to a “diagnostic” microarray that contained 60 mer probes of the 18,723 full-set sequences along with control sequences. To minimize cross-hybridization, the PCR recognition site common ends were removed from the 18,723 shRNA oligonucleotide probes on the diagnostic array.

A single-mode distribution of brightly and dimly hybridizing (high and low intensity) probes on the diagnostic microarray for the full-set pool was observed. As expected, bimodal distributions for the subset pools were observed. After normalization for background hybridization using negative controls on the microarray, labeled IVT product from the full-set of sequences hybridized to ˜99.8% of the unique sequence probes. The collective data for the four subset oligonucleotide pools revealed ˜390 sequences that showed overlap in hybridization among all four sets. This overlap was not intended by the sequence set designs. On further inspection, the members of this set of sequences shared a highly conserved internal core sequence of about 10 consecutive bases (5′ GGGTTGGCTC 3′, SEQ ID NO:1) that included the conserved shRNA loop structure. These fortuitous stretches of sequence conservation among the oligonucleotides likely explains the cross hybridization observed. Of the probes on the microarray, 909 sequences contain the sequence 5′ GGGTTGGCTC 3′ (SEQ ID NO:1) from positions 27-36.

As a visual illustration of the coverage afforded by our library pools, the 909 redundant simple sequences were eliminated and a two-dimensional intensity cluster analysis of 17,552 good probes (representing more than 98% of the 17,898 valid probes) was carried out with the bright hybridizing probes for the subset arrays. Each cleaved subset array gave a unique signature. As expected, small clusters of bright probes for each array that were also bright for intended overlapping arrays were observed. The data from the subset arrays was used to calculate false positive and false negative hybridizations. A false positive for a subset array was defined as a sequence determined to have significant representation in hybridization but not belonging to the 5,152 sequences actually printed on the array from which the oligonucleotide pool was obtained. A false negative was defined as a sequence that is not significantly represented in hybridization although it is one of the intended sequences. For each subset array, the threshold for the representation significance is calculated such that the sum of the false positive rate and the false negative rate is minimized. The computed threshold essentially segments the bimodal probe intensity distribution into two groups, the represented sequences and the background. The same approach can be extended to the full-set array to estimate the number of sequences that are represented, in which case the representation threshold segments the full-set probes (represented) from the negative controls probes (background). With this approach, an average false positive rate of 6.15% and an average false negative rate of 1.99% were obtained. The higher, but still quite low, false positive rate likely results from a much smaller set of sequence redundancies that remain after removal of the 909 5′ GGGTTGGCTC 3′ (SEQ ID NO:1)-containing sequences. Thus, the true false positive rate probably approaches that of the false negative rate. All combined, these data illustrate that this standard microarray approach to evaluating library representation is valid and suggests that intended sequences within a pool of oligonucleotides cleaved from a microarray are extremely well represented.

There was a surprising lack of bias in the amplification step of the method. Since complex pools of PCR templates with non-degenerate primer binding sites are rarely used for amplification, there was a concern that specific sequences might exhibit bias in the reactions and that this bias could, in fact, be random. Not only did the data demonstrate good representation of the pool, but sequencing and FASTA alignment of a set of 288 clones demonstrated that these concerns were unfounded.

By utilizing standard fluorescent labeling schemes, this type of library can assess representation of cleaved material by hybridization to a complementary microarray. A logical extension of the approach is the generation of a common reference for use in ratio microarray experiments.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for evaluating the presence or absence of expected nucleic acid molecules in a library of synthesized nucleic acid molecules comprising the steps of:
(a) hybridizing a sample population of nucleic acid molecules obtained from a library comprising at least 1000 nucleic acid molecules synthesized on a first solid substrate to a second substrate comprising a population of at least 1000 target nucleic acid molecules, wherein:
(i) each target nucleic acid molecule in the population of target nucleic acid molecules comprises a nucleic acid sequence that is identical or complementary to at least a portion of a plurality of the at least 1000 nucleic acid molecules present in the library of synthesized nucleic acid molecules, and
(ii) each target nucleic acid molecule is localized to a defined area of the second substrate;
(b) detecting hybridization signals from the sample population hybridized to the second substrate according to step (a); and
(c) determining the presence or absence of the at least 1000 nucleic acid molecules in the library of synthesized nucleic acid molecules by analyzing the hybridization signals detected in step (b).

2. The method of claim 1, wherein the sample population of nucleic acid molecules are labeled before hybridization to the substrate.

3. The method of claim 1, wherein the substrate comprises at least about 30,000 target nucleic acid molecules.

4. The method of claim 1, wherein the sample population of nucleic acid molecules are single-stranded RNA molecules.

5. The method of claim 1, wherein the target nucleic acid molecules are single-stranded DNA molecules.

6. The method of claim 1, wherein the substrate comprises a nucleic acid molecule that provides a negative control for background hybridization.

7. The method of claim 1, wherein step (c) is accomplished using cluster analysis.

8. A method for evaluating the presence or absence of expected nucleic acid molecules in a library of synthesized nucleic acid molecules, comprising the steps of:
(a) synthesizing a population of labeled, single-stranded RNA molecules from a library comprising at least 1000 nucleic acid molecules synthesized on a first solid substrate;
(b) hybridizing the population of labeled, single-stranded RNA molecules to a second substrate comprising a population of at least 1000 target nucleic acid molecules, wherein:
(i) each target nucleic acid molecule in the population of target nucleic acid molecules comprises a nucleic acid sequence that is identical or complementary to at least a portion of a plurality of the at least 1000 nucleic acid molecules present in the library of synthesized nucleic acid molecules; and
(ii) each target nucleic acid molecule is localized to a defined area of the second substrate;
(c) detecting hybridization signals from the population of labeled, single-stranded RNA molecules hybridized to the second substrate according to step (b); and
(d) determining the presence or absence of the labeled, single-stranded RNA molecules synthesized from the library of synthesized nucleic acid molecules by analyzing the hybridization signals from step (c), thereby evaluating the presence or absence of the at least 1000 nucleic acid molecules in the library of synthesized nucleic acid molecules.

9. The method of claim 8, wherein the substrate comprises a nucleic acid molecule that provides a negative control for background hybridization.

10. The method of claim 8, wherein step (d) is accomplished using cluster analysis.

11. A method for evaluating the presence or absence of expected nucleic acid molecules in a population of synthesized nucleic acid molecules, comprising the steps of:
(a) synthesizing on a first solid substrate a population comprising at least 1000 nucleic acid molecules;
(b) harvesting the population of synthesized nucleic acid molecules from the first solid substrate to yield harvested nucleic acid molecules,
(c) synthesizing a population of labeled, single-stranded RNA molecules from the population of harvested nucleic acid molecules;
(d) hybridizing the population of labeled, single-stranded RNA molecules to a second substrate comprising a population of at least 1000 target nucleic acid molecules, wherein:
(i) each target nucleic acid molecule in the population of target nucleic acid molecules comprises a nucleic acid sequence that is identical or complementary to at least a portion of a plurality of the at least 1000 nucleic acid molecules present in the population of nucleic acid molecules synthesized on the first substrate; and
(ii) each target nucleic acid molecule is localized to a defined area of the second substrate;
(e) detecting hybridization signals from the population of labeled, single-stranded RNA molecules hybridized to the second substrate according to step (d); and
(f) determining the presence or absence of the labeled, single-stranded RNA molecules synthesized from the library of synthesized nucleic acid molecules by analyzing the hybridization signals detected in step (e), thereby evaluating the presence or absence of the at least 1000 nucleic acid molecules in the synthesized population of nucleic acid molecules of step (a).

12. The method of claim 11, wherein the second substrate comprises a nucleic acid molecule that provides a negative control for background hybridization.

13. The method of claim 11, wherein step (f) is accomplished using cluster analysis.

14. The method of claim 11 further comprising amplifying the population of harvested nucleic acid molecules according to step (b) prior to synthesizing the population of labeled, single-stranded RNA molecules according to step (c).

15. A method for evaluating the presence or absence of expected nucleic acid molecules in a population of synthesized nucleic acid molecules, comprising the steps of:
(a) synthesizing on a first solid substrate a population comprising at least 1000 nucleic acid molecules to generate a synthesized population of nucleic acid molecules;
(b) harvesting the synthesized population of nucleic acid molecules from the first solid substrate to yield a harvested population of synthesized nucleic acid molecules;
(c) hybridizing a sample population of the harvested population of synthesized nucleic acid molecules from step (b) to a second substrate comprising a population of at least 1000 target nucleic acid molecules, wherein:
(i) each target nucleic acid molecule in the population of target nucleic acid molecules comprises a nucleic acid sequence that is identical or complementary to at least a portion of a plurality of the at least 1000 nucleic acid molecules present in the synthesized population of nucleic acid molecules; and
(ii) each target nucleic acid molecule is localized to a defined area of the second substrate;
(d) detecting hybridization signals from the sample population hybridized to the second substrate according to step (c); and
(e) determining the presence or absence of the at least 1000 nucleic acid molecules in the synthesized population of nucleic acid molecules by analyzing the hybridization signals detected in step (d).


SEQUENCE LISTING (1 sequence)

SEQ ID NO: 1 - DNA, 10 bp, Artificial Sequence
  Oligonucleotide
gggttggctc